(19) United States
(12) Patent Application Publication
(10) Pub. No.: US 2026/0142784 A1
(43) Pub. Date: May 21, 2026

(54) COMMUNICATION DEVICE AND METHOD

(71) Applicant: Sony Group Corporation, Tokyo (JP)

(72) Inventors: Pukar SHAKYA, Stuttgart (DE); Thomas HANDTE, Stuttgart (DE); Daniel VERENZUELA, Stuttgart (DE); Ken TANAKA, Stuttgart (DE)

(73) Assignee: Sony Group Corporation, Tokyo (JP)

(21) Appl. No.: 19/121,845

(22) PCT Filed: Nov. 2, 2023
(86) PCT No.: PCT/EP2023/080511

§ 371 Date: Apr. 17, 2025

(30) Foreign Application Priority Data
Nov. 9, 2022 (EP) 22206433.9

(51) Int. Cl. H04L 5/00; H04L 1/00

(52) U.S. Cl. CPC H04L 5/0053; H04L 1/0003

(57) ABSTRACT

A first communication device that is configured to communicate with a second communication device having circuitry configured to obtain user data length information indicating the length of one or more data units of user data to be transmitted to the second communication device; obtain at least two transmission parameter sets each including transmission parameters for use in the transmission of the user data, the at least two transmission parameter sets having one or more different parameter values; determine, from the user data length information and the at least two transmission parameter sets, encoding parameters that are identical regardless which transmission parameter set is used for transmission of the user data; encode the user data into transmission data units according to the determined encoding parameters; and modulate and transmit the transmission data units to the second communication device according to one of the transmission parameter sets.

### BACKGROUND

### Field of the Disclosure

The present disclosure relates to communication device and method, in particular for use in wireless LAN (WLAN) systems.

### Description of Related Art

WLAN features hybrid automatic repeat request (HARQ) type I which features a combination of forward error correction (FEC) and automatic repeat request (ARQ) protocol. Thereby, any medium access control (MAC) layer data unit to be transmitted is first supplied with a frame check sequence (FCS) and then encoded by a forward error correction encoder such as low-density parity-check (LDPC) code. Upon reception, the receiver (herein also called “second communication device”) performs FEC decoding and subsequently checks the validity of FCS. If the FCS is valid, the automatic repeat request (ARQ) mechanism transmits a positive acknowledgement (ACK) to the transmitter (herein also called “first communication device”) to indicate successful reception. If the FCS is invalid, the ARQ mechanism transmits a negative acknowledgement (N-ACK) or nothing to the transmitter to indicate that a retransmission of the MAC layer data unit is needed. After a certain number of retransmissions, e.g., depending on a lifetime of a data unit, the transmission was either successful or not, in which case the MAC layer data unit is discarded at the transmitter. Thus, in poor channel conditions where signal strength is weak, HARQ type I may fail to provide reliable communication because initial (original) transmission and retransmissions may fail.

Link adaptation is one of the methods of adapting to a time varying channel to provide a sustainable and reliable communication system. In IEEE 802.11 a link adaptation mechanism can switch among different physical layer (PHY) parameters such as modulation coding scheme (MCS) depending upon the pass-fail ratio of acknowledgments received at the transmitter side.

The “background” description provided herein is for the purpose of generally presenting the context of the disclosure. Work of the presently named inventor(s), to the extent it is described in this background section, as well as aspects of the description which may not otherwise qualify as prior art at the time of filing, are neither expressly nor impliedly admitted as prior art against the present disclosure.

### SUMMARY

It is an object to provide a communication device and method that can increase the link reliability and robustness of the wireless communication and, hence, can increase the overall efficiency of the system. It is a further object to provide a corresponding computer program and a non-transitory computer-readable recording medium for implementing said methods.

According to an aspect there is provided a first communication device configured to communicate with a second communication device, the first communication device comprising circuitry configured to
obtain user data length information indicating the length of one or more data units of user data to be transmitted to the second communication device;
obtain at least two transmission parameter sets each including transmission parameters for use in the transmission of the user data, the at least two transmission parameter sets having one or more different parameter values;
determine, from the user data length information and the at least two transmission parameter sets, encoding parameters that are identical regardless which transmission parameter set is used for transmission of the user data;
encode the user data into transmission data units according to the determined encoding parameters; and
modulate and transmit the transmission data units to the second communication device according to one of the transmission parameter sets.

According to further aspects a corresponding communication method, a computer program comprising program means for causing a computer to carry out the steps of the methods disclosed herein, when said computer program is carried out on a computer, as well as a non-transitory computer-readable recording medium that stores therein a computer program product, which, when executed by a processor, causes the method disclosed herein to be performed are provided.

Embodiments are defined in the dependent claims. It shall be understood that the disclosed communication method, the disclosed computer program and the disclosed computer-readable recording medium have similar and/or identical further embodiments as the claimed communication devices and as defined in the dependent claims and/or disclosed herein.

One of the aspects of the disclosure is a link adaptation in context of Hybrid ARQ soft combining techniques such as chase combining (CC) or/and incremental redundancy (IR). In order to implement soft combining of an initial transmission with a retransmission, the encoding structure should remain unchanged between each transmission. A mechanism is disclosed that ensures the same encoding structure even though various parameters (in particular PHY parameters) change over the process of (re) transmissions. In more detail, the length of the data field of a data unit (e.g. a PPDU) is selected such that, after the processing operations, it results in the same size, regardless of which parameters are applied.

The foregoing paragraphs have been provided by way of general introduction and are not intended to limit the scope of the following claims. The described embodiments, together with further advantages, will be best understood by reference to the following detailed description taken in conjunction with the accompanying drawings.

### BRIEF DESCRIPTION OF THE DRAWING

A more complete appreciation of the disclosure and many of the attendant advantages thereof will be readily obtained as the same becomes better understood by reference to the following detailed description when considered in connection with the accompanying drawings, wherein:

FIG. 1 shows a diagram illustrating the relationship between MPDU, PSDU and PPDU as used in current WLAN systems.

FIG. 2 shows a schematic diagram of a communication system.

FIG. 3 schematically shows an encoding and decoding scheme as used in a communication system for WLAN.

FIG. 4 shows a schematic diagram of a conventional communication scheme.

FIG. 5 shows a schematic diagram of a PHY transmit procedure according to the current WLAN operation.

FIG. 6 shows a schematic diagram of the layout of a conventional transmitter.

FIG. 7 shows a table of exemplary values of different parameters.

FIG. 8 shows a diagram illustrating different codeword structures for initial transmission and for retransmission when using the conventional transmission scheme.

FIG. 9 shows a diagram illustrating the different fields of a PPDU.

FIG. 10 shows a schematic diagram of an embodiment of a transmitter according to the present disclosure.

FIG. 11 shows a diagram illustrating identical codeword structures for initial transmission and for retransmission when using the transmission scheme of the present disclosure.

FIG. 12 shows a diagram illustrating the codeword structure for an initial transmission and for a retransmission with different modulation order.

FIG. 13 shows a schematic diagram of an embodiment of a communication scheme according to the present disclosure.

FIG. 14 shows a schematic diagram of a calculation unit 90 according to the present disclosure.

FIG. 15 shows a flow chart of a communication method according to the present disclosure.

### DETAILED DESCRIPTION OF THE EMBODIMENTS

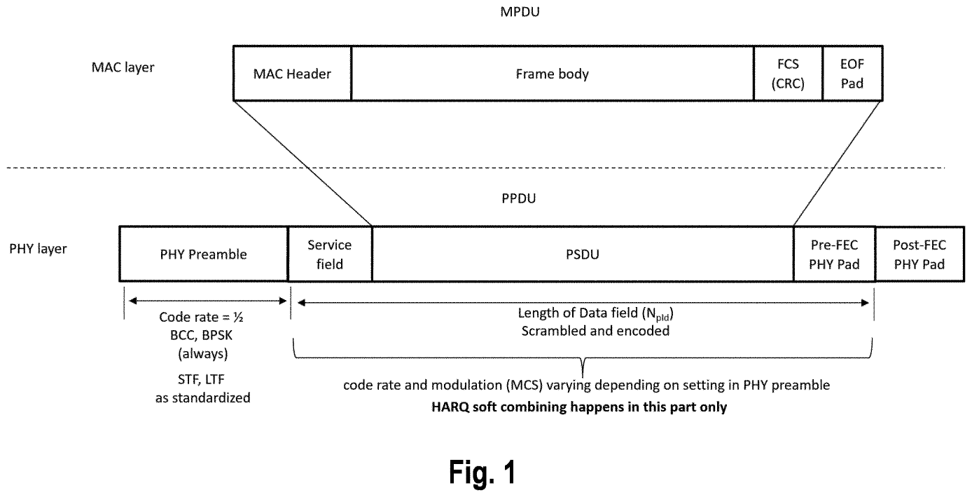

Referring now to the drawings, wherein like reference numerals designate identical or corresponding parts throughout the several views, FIG. 1 shows a diagram illustrating the relationship between MAC protocol data unit (MPDU), PLCP (physical layer convergence protocol) service data unit (PSDU) and physical layer protocol data unit (PPDU) as used in current WLAN systems. Basically, an MPDU includes a frame check sequence (FCS), that contains cyclic redundancy check (CRC) bits, which will allow to detect the error, if any, in the MPDU at the receiver side. This data unit along with the end of field (EOF) padding is later on forwarded to the PHY layer as PPDU as shown in FIG. 1, which is then scrambled and encoded by the forward error correction code such as low-density parity check (LDPC) code.

At the receiver side, after receiving the PPDU, it is decoded by an LDPC decoder and forwarded to the MAC layer. The decoded data unit is checked by FCS if there is any bit error. If the FCS is valid, then the receiver will send a positive acknowledgement to the transmitter to acknowledge that the data unit has been received correctly. If the FCS fails, then an ARQ protocol will send a negative acknowledgement to the transmitter to trigger a retransmission of the same data unit or information related to that data unit. The erroneously received data unit is generally discarded completely at the receiver.

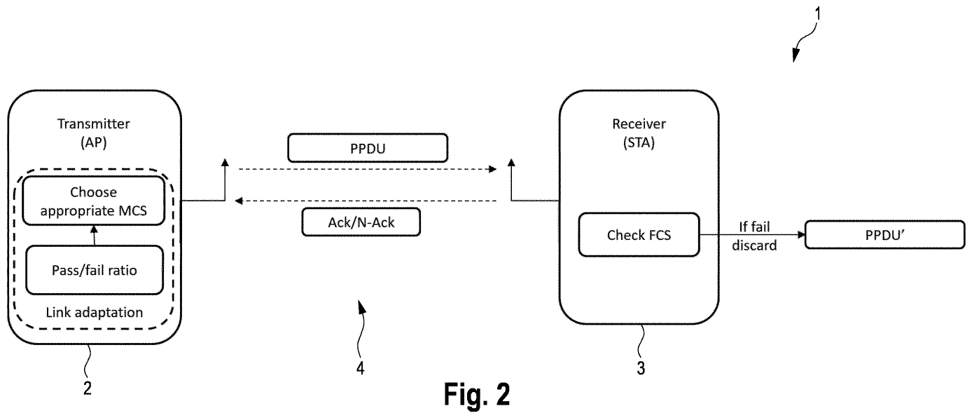

FIG. 2 shows a schematic diagram of a communication system 1 comprising a transmitter 2 (e.g. an access point (AP)) and a receiver 3 (e.g. a station (STA)) that are configured to communicate with each other over a communication channel 4. For instance, the transmitter 2 transmits data units of user data included in PPDUs to the receiver 3 which responds by transmitting acknowledgments (Ack) or non-acknowledgements (N-Ack).

Conventionally, based on the pass/fail ratio of a received acknowledgement from the receiver 3, the transmitter 2 performs link adaptation and chooses the appropriate MCS for the transmission of the data units. Typically, the transmitter 2 holds a table which contains in ideal case for each PHY parameter setting a success ratio and estimated throughput. Based on the table, it selects PHY parameters according to the need of the current data transmission. For example, a high throughput setting may be used for an initial transmission and a high success ratio setting may be used for a retransmission. Often the table is updated on a try-and-error basis, meaning that PPDUs are opportunistically transmitted with certain PHY settings to explore the performance of the particular setting.

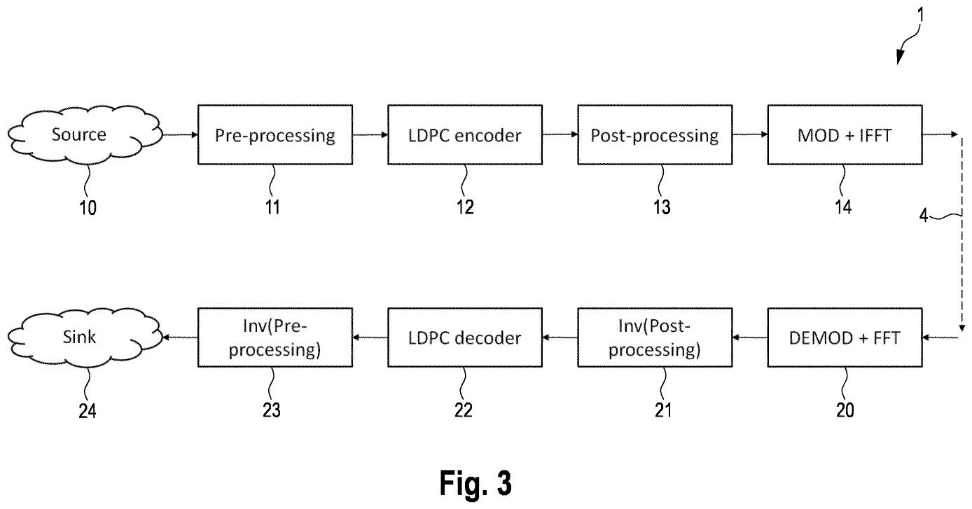

The encoding and decoding scheme as used in a communication system 1 for WLAN is schematically shown in FIG. 3 for an LDPC code. The source provides the scrambled data of payload bits and FCS (CRC bits). These data are subsequently encoded and OFDM modulated to transmit over the wireless channel. LDPC codes operate with a codeword length. Therefore, when the user data has a variable size, pre- and post-processing is needed in order to fit the varying number of bits to one or more codewords. The LDPC encoding process in WLAN simultaneously fit the scrambled bits into a required minimum number of OFDM symbols and an integer number of codewords.

The pre-processing unit 11 determines the required minimum number of OFDM symbols (N_{SYM}) according to the total number of scrambled bits coming from the source 10. This unit also determines the codeword (CW) length (L_{LDPC}) and computes the number of codewords (N_{CW}) based on total number of scrambled bits. It shall be noted in this context that WLAN LDPC encoding offers three different code word size LDPC codes. They are selected depending on total number of scrambled bits. Typically, the largest code word size of 1944 bits is used, because a typical data unit length is 1500 bytes or 12000 bits. If the bits from the total number of scrambled data cannot fill the information part of N_{CW} codewords completely before encoding, then the required shortening bits (Nₛₕᵣₜ) are calculated. Shortening bits are bits of fixed value that are added to the information part of each codeword before the encoding, but which are discarded before transmission. The receiver includes those bits of fixed value before decoding. These shortened bits are not always possible to be equally distributed to the number of codewords. Hence, the first mod (Nₛₕᵣₜ, N_{CW}) codewords contain one more shortening bit than remaining codewords. The minimum number of shortening bits per codeword N_{spcw}=[Nₛₕᵣₜ/N_{CW}] are inserted.

The output of the pre-processing unit 11 is systematically encoded with the LPDC encoder 12 with the designated code rate (R) as per modulation and coding scheme (MCS) to obtain the codewords. In the post-processing unit 13, the inserted shortening bits in the information part of codewords are removed and either puncturing of the parity part of codewords (if the encoded bits are more than OFDM symbols can carry) or a repetition of the information part of codewords (if the encoded bits are less to fit the OFDM symbols) is performed. In a case where the total number of parity bits to be punctured to fit in OFDM symbols is too large, the coding performance will degrade. To avoid this, an extra OFDM symbol will be added if either of the following two conditions is met:
If the total number of punctured bits (N_{punc}) exceeds 30% of the total number of parity bits:

$${N}_{p u n c} > 0.3 * {N}_{C W} * {L}_{L D P C} * ( 1 - R ) ,$$

if the following two sub-conditions are true:

$${N}_{p u n c} > 0.1 * {N}_{C W} * {L}_{L D P C} * ( 1 - R ) AND {N}_{s h r t} < 1.2 * {N}_{p u n c} * \frac{R}{1 - R} .$$

The output of post-processing unit 13 is then modulated as per MCS and undergoes IFFT in a modulation and IFFT unit 14 before it is transmitted over a wireless channel 4 as an OFDM signal. At the receiver, after FFT processing and demodulation in an FFT and demodulation unit 20, the inverse processes of the encoding procedure are carried out in an inverse post-processing unit 21, an LDPC decoder 22 and an inverse pre-processing unit 23 to retrieve the payload bits provided to the sink 24. The LDPC decoder 22, in WLAN, uses the belief propagation algorithm to decode a binary systematic LDPC code, whose input is the soft decision bitwise log-likelihood ratio (LLR) values from a demodulator 20. The received signal, after passing through the demodulator 20, is sampled, and real values are measured for soft decision de-mapping. These real values are soft decision value of received bits for the corresponding bits in the M-ary modulated constellation points and are termed as bitwise LLR values.

The maximum likelihood searches the constellation points with a higher probability to estimate LLR for each received bit in the received signal. Mathematically, LLR is the ratio of probabilities of a 0 bit being transmitted to the 1 bit being transmitted for a received signal and can be expressed as Eq. (1) where b is the transmitted bit (one of k bits in an M-ary symbol) and r is received signal with coordinates (x, y) in constellation diagram.

$$L ( b ) = log ( \frac{P r ( b = 0 \vert r = ( x , y ) )}{P r ( b = 1 \vert r = ( x , y ) )} ) \qquad ( 1 )$$

After applying Bayes rules and assuming all symbols are equally probable, the LLR value of code bit after passing a signal over additive white gaussian noise (AWGN) is expressed by Eq. (2) where S₀/S₁ is the constellations point with bit 0/1 at the given bit position, sₓ/s_{y} is the in-phase/quadrature coordinate of the constellation point, o² is the noise variance of the baseband signal.

$$L ( b ) = log ( \frac{{\sum }_{s ∈ {S}_{0}} {e}^{- \frac{1}{{σ}^{2}} ( {( x - {s}_{x} )}^{2} + {( y - {s}_{y} )}^{2} )}}{{\sum }_{s ∈ {S}_{1}} {e}^{- \frac{1}{{σ}^{2}} ( {( x - {s}_{x} )}^{2} + {( y - {s}_{y} )}^{2} )}} ) \qquad ( 2 )$$

To summarize, an LLR value is a real number that indicates per bit the reliability of said bit. The more positive the value, the more likely a 0 bit was detected, whereas the more negative, the more likely a 1 bit was detected. A LLR value of zero means that both bits are equally probable.

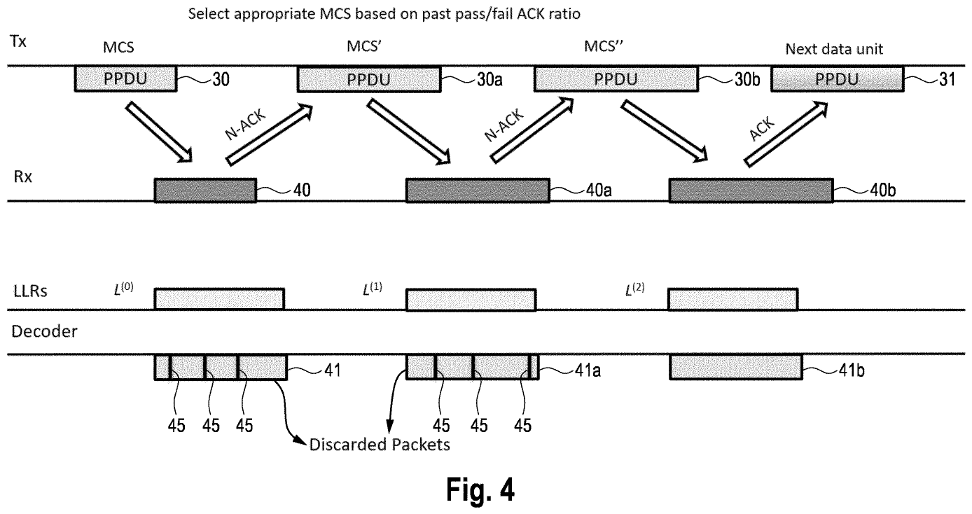

FIG. 4 shows a schematic diagram of a conventional communication scheme used by the communication system 1 shown in FIGS. 2 and 3 according to which the PHY parameter MCS is changed for retransmissions, e.g. based on the past pass/fail ACK ratio. In particular, in the exemplary embodiment the originally (initially) transmitted PPDU 30 is retransmitted two times as PPDUs 30a and 30b, each time using a different MCS (indicated as MCS, MCS' and MCS″). In other embodiment only one or more than two retransmissions may be made. At the receiver, the erroneously received data units 40, 40a (indicated in FIG. 4 by the presence of error bits 45 in the respective information parts 41, 41a of the received data units 40, 40a) and their LLR values L⁽⁰⁾, L⁽¹⁾ are discarded. In response to a N-ACK, representing an indication indicating at least one erroneous data unit that failed to be received or decoded by the receiver, the transmitter retransmits the same data unit 30 again (in this case two times, indicated as data units 30a, 30b) leading to another erroneously received data unit 40a and a correctly received data unit 40b (indicated by the absence of error bits in the respective information part 41b of the received data unit 40b) with LLR value L⁽²⁾, which is confirmed by transmitting ACK to the transmitter. The transmitter will then send the next (different) data unit 31. After a certain number of retransmissions depending on a lifetime of a data unit, the transmission was either successful or not in which case the data unit is discarded at the transmitter side as well.

Instead of discarding the erroneously received data unit at the receiver side, it can be stored and utilized to extract some relevant information that may help in decoding the data unit in successive retransmissions. Soft combining is one of the techniques that combines the LLR values of a stored erroneous data unit with a retransmitted data unit which can help the decoder to decode it correctly. Moreover, link adaptation by changing PHY parameters such as the MCS from e.g. higher modulation scheme to more robust lower modulation scheme in a retransmission may increase the likelihood of correct decoding even more.

The combination of link adaptation and HARQ soft combining can provide more reliable and robust communication but implementing both procedures together may need some specific requirements to make it compatible with the current WLAN standard specifications according to IEEE 802.11. Link adaptation with HARQ soft combining will run only when there is a retransmission of the same or related information to erroneously received data unit at the receiver.

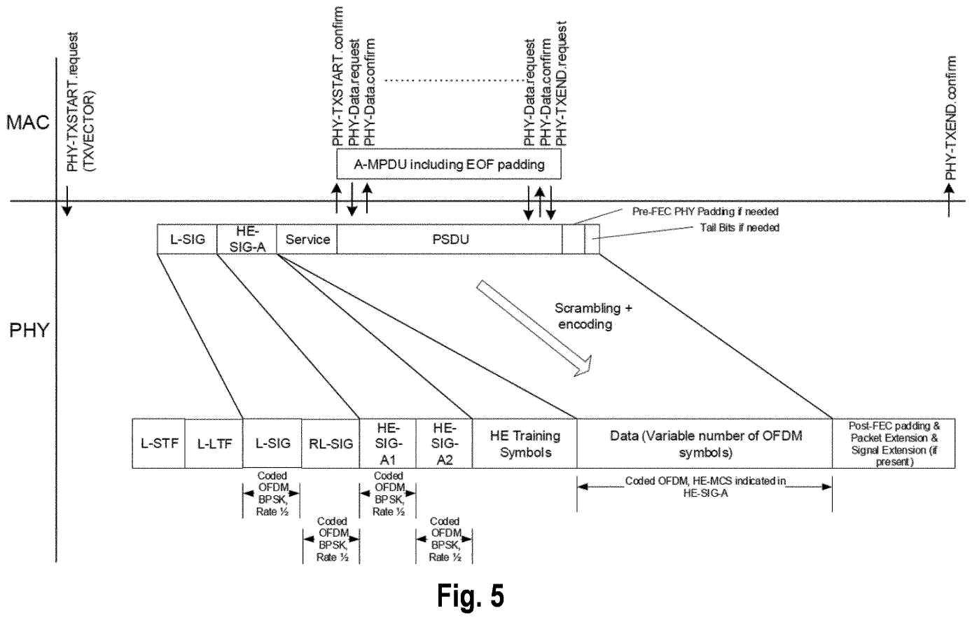

FIG. 5 shows a schematic diagram of a PHY transmit procedure according to the current WLAN operation. When a transmission process is initiated, the MAC layer gives a desired length of one or more data units (A_PEP_LENGTH in bytes) to be transmitted to the PHY layer. This request includes also the PHY parameters to be used for the upcoming transmission. A_PEP_LENGTH and PHY parameters are included in the PHYTXSTART.request primitive within the TXVECTOR. Subsequently, the PHY layer starts processing and computes the actual length (PSDU_LENGTH in bytes) it can transmit.

This length is indicated in PHY-TXSTART.confirm primitive and may be different than A_PEP_LENGTH (larger or equal) depending on A_PEP_LENGTH and PHY parameters. Subsequently, the MAC layer performs padding such that the PSDU_LENGTH is met. As shown in FIG. 5, data exchange between the MAC layer and the PHY layer takes place via zero or more PHY-DATA.request and PHY-DATA.response exchanges. Whereas the PHY padding by the PHY layer is illustrated in FIG. 5 by “Pre-FEC PHY Padding”, the MAC padding by the MAC layer is illustrated by “including EOF padding” and affects the number of PHY-DATA.request/response exchanges at the end.

The reason for PSDU_LENGTH being a function of A_PEP_LENGTH and PHY parameters is that there are two objectives that should be met by the PHY layer: The first objective is to encode the data units in an integer number of LDPC codewords and the second objective is to modulate an integer number of OFDM symbols.

In general, the PSDU_LENGTH (in bytes) is calculated as

$$PSDU\_LENGTH = ⌊ \frac{8 * A\_PEP \_LENGTH + {N}_{P A D , pre - FEC}}{8} ⌋ \qquad ( 3 )$$

with N_{PAD,pre-FEC}=N_{PAD,pre-FEC,PHY}+N_{PAD,pre-FEC,MAC} is pre-FEC padding in bits wherein N_{PAD,pre-FEC,PHY}=N_{PAD,pre-FEC} mod 8 being a number between 0 and 7 and

$${N}_{P A D , pre - FEC , MAC} = ⌊ \frac{{N}_{PAD , pre - FEC}}{8} ⌋ * 8$$

being a integer multiple of 8. Thus, the padding in the MAC layer pads to the last bytes, whereas the PHY layer pads to remaining bits. The N_{PAD,pre-FEC} is present to meet the above objectives of getting an integer number of OFDM symbols and LDPC codeword lengths.

The number of payload bits that are encoded is N_{pld} in bits and given by

$${N}_{p l d} = {N}_{service} + 8 * {PSDU}_{LENGTH} + {N}_{P A D , pre - FEC , PHY} . \qquad ( 4 )$$

If, as a simple example, A_PEP_LENGTH=285 bytes (2280 bits) should be transmitted in 20 MHz bandwidth of 242−Resource Unit (N_{SD}=234 data subcarriers) with code rate R=3/4 and modulation (Mod) scheme 16-QAM, then that conveys 702 data bits per OFDM symbol (N_{DBPS}), 4 OFDM symbols (N_{SYM}) and 170 bits pre-FEC padding (including both pre-FEC PHY and MAC padding). If, instead, QPSK is used, then it conveys 351 data bits per OFDM symbol, 7 OFDM symbols and 80 bit pre-FEC padding. Thus, although the ratio of data bits per OFDM symbol is 2, the number of OFDM symbols has different ratio. All this has an impact to the coding structure, i.e., how many bits of each LDPC codeword are shortened, punctured, and/or repeated.

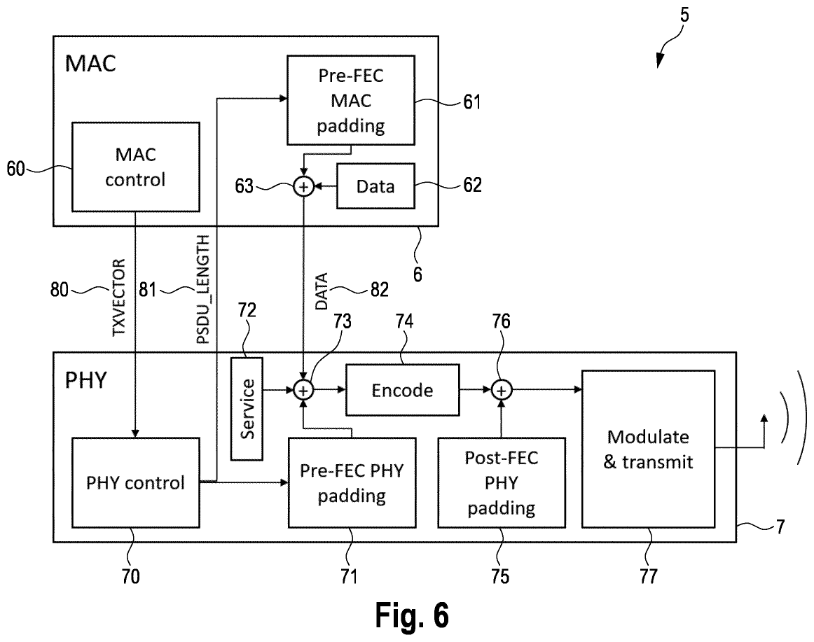

FIG. 6 shows a schematic diagram of the layout of a conventional transmitter 5 to illustrate the transmission process and in particular the padding process in more detail. The transmitter 5 comprises a MAC layer processing unit 6 and a PHY layer processing unit 7. The MAC layer processing unit 6 comprises a MAC control unit 60 that indicates TXVECTOR 80 to a PHY control unit 70 of the PHY layer processing unit 7, which returns the PSDU_LENGTH 81 that determines pre-FEC MAC and pre-FEC PHY padding. The actual transmit data 62 is concatenated with the pre-FEC MAC padding bits 61 in a MAC concatenation unit 63. The resulting data 82 are passed to the PHY layer 7, where pre-FEC PHY padding bits 71 are added by a PHY concatenation unit 73 along with N_{service}=16 bits for a service field 72. These concanated bit streams are then encoded in an encoding unit 74 as per MCS. After the encoding, post-FEC PHY padding bits 75 may be added by an adder 76 to fill in the last OFDM symbol, if required, to the bit stream, which is then finally modulated and transmitted by a modulator and transmitter 77. It shall be noted that often a pipelined process is implemented, meaning that the padding is added as needed while the data is already transmitted, i.e., there may be no memory that stores all data before transmission.

For soft combining, content of a data field of a PPDU should not change between original transmission and retransmission (i.e. the originally transmitted and the retransmitted PPDUs shall contain the identical data field). Further, the coding structure shall remain unchanged. Therefore, soft combining for the above example where 16-QAM is used in the initial transmission (MCS: 4) and QPSK is used for retransmission (MCS: 2) does not work even for the same code rate due to a change in PSDU_LENGTH and pre-FEC padding which leads to different lengths of the data field N_{pld} to encode, respectively.

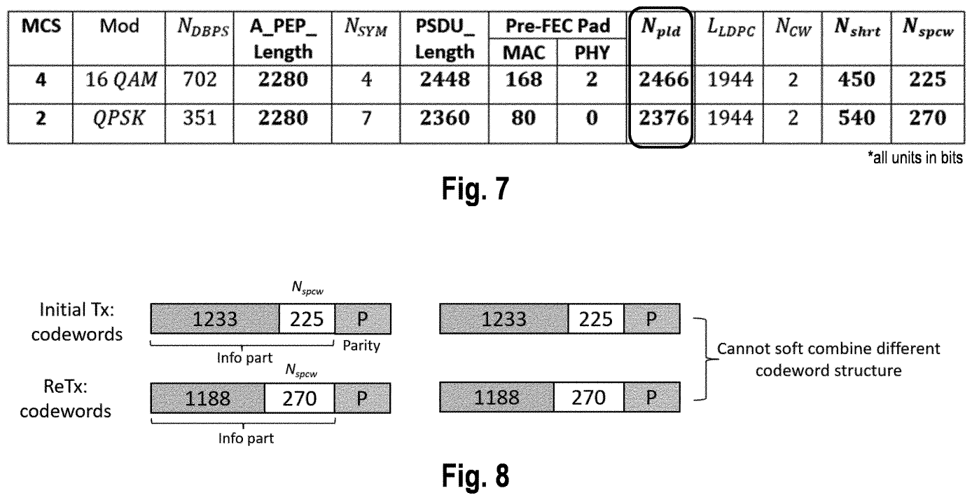

FIG. 7 shows a table (Table 1) of exemplary values of different parameters, in particular of a different length of the data field (N_{pld}) for the same A_PEP_LENGTH while changing the MCS (all units in bits). For A_PEP_LENGTH=2280 bits from the above example, for the calculated N_{pld} and the number of available encoded bits to transmit, a codeword size may be chosen as L_{LDPC}=1944 and the number of codewords N_{CW} required is 2. With a code rate R=3/4, the information part requires 1458 bits to be encoded.

Due to different N_{pld} in initial transmission and retransmission, the number of shortening bits per codeword (N_{spcw}) to be added is 225 and 270 bits, respectively, to fill in the information part before encoding. After systematic encoding, a parity part P is generated. The codewords are formed as illustrated in FIG. 8 showing different codeword structures for the initial transmission (first row) and for the retransmission (second row). Hence, the codeword structure in initial transmission and retransmission has been changed which is not soft-combinable.

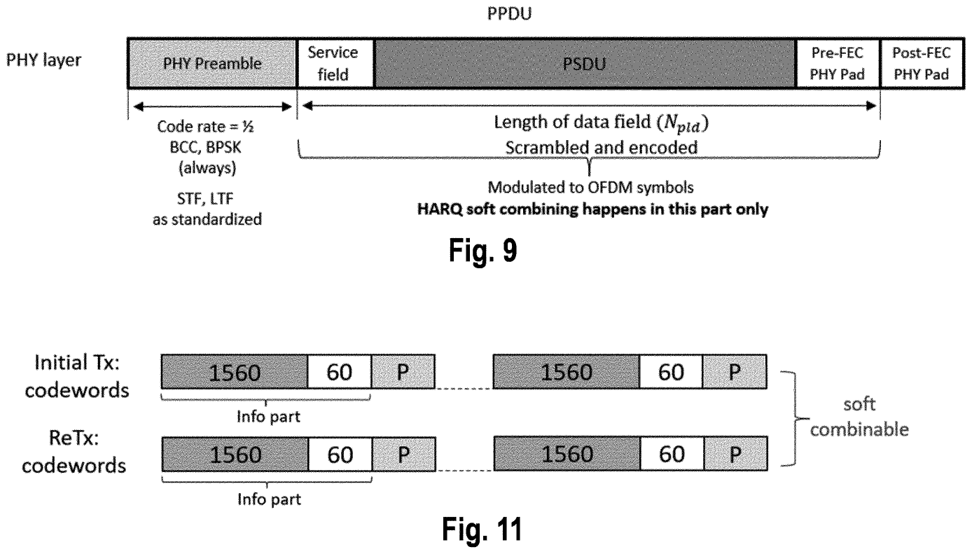

FIG. 9 shows a diagram illustrating the different fields of a PPDU. HARQ soft combining technique is applying only in the data field of the PPDU. Hence, in retransmissions, the content and length of the data field (N_{pld}) should be the same along with the same state of a scrambler unit as in the initial transmission. The following disclosure describes an implementation of a link adaptation protocol with HARQ soft combining using the LDPC encoding under the current WLAN IEEE 802.11 standard specifications.

As a necessary and sufficient condition to achieve the same coding structure, it can be derived that the PSDU_LENGTH should be the same between retransmissions. As the (user) data should be identical in each transmission, its A_PEP_LENGTH and therefore the pre-FEC MAC and PHY padding should be the same as well, which ensures the same length of the data field N_{pld}.

However, the length of data field may vary when switching from one set of PHY parameters to another in retransmissions which may lead to a different PSDU_LENGTH and Pre-FEC PHY padding, even if chosen from the same code rate family as shown above in Table 1 depicted in FIG. 7 for the example of changing MCS.

In the following, an overview about the encoding mechanism within the IEEE 802.11 standard specification for 802.11ax and 802.11be is provided. The initial number of OFDM symbols N_{SYM,init} required to carry the data coming from the MAC layer, given by the A_PEP_LENGTH, is calculated according to Eq. (5).

$${N}_{S Y M , i n i t} = ⌈ \frac{8 * A\_PEP \_LENGTH + {N}_{service}}{{N}_{DBPS}} ⌉ \qquad ( 5 )$$

Hence, while preparing the data field of a PPDU in order to fill the OFDM symbols, depending upon A_PEP_LENGTH, additional Pre-FEC padding bits (on the MAC and/or PHY layer) may or may not be required to be added when divided by N_{DBPS}. The factor N_{DBPS} is calculated as in Eq. (6) which is dependent on PHY parameters such as the number of data subcarriers N_{SD}, the number of coded bits per single carrier N_{BPSCS}, the number of spatial streams N_{SS}, bandwidth, Resource Unit (RU) size, and code rate R. Other parameters may have a non-linear impact on N_{DBPS} as well.

$${N}_{DBPS} = {N}_{S D} * {N}_{B P S C S} * {N}_{s s} * R \qquad ( 6 )$$

For example, in case of IEEE 802.11be EHT 242-tone RU (N_{SD}=234) and N_{SS}=1, N_{DBPS} is given by the following Table 2 (MCSs are grouped together with the same code rate).

TABLE 2

| MCS | Mod | | Code rate (R) | Nₛₛ | N_{SD} | N_{DBPS} (bits) |
|---|---|---|---|---|---|---|
| 13 | 4096 | QAM | 5/6 | 1 | 234 | 2340 |
| 11 | 1024 | QAM | 5/6 | 1 | 234 | 1950 |
| 9 | 256 | QAM | 5/6 | 1 | 234 | 1560 |
| 7 | 64 | QAM | 5/6 | 1 | 234 | 1170 |
| 12 | 4096 | QAM | 3/4 | 1 | 234 | 2106 |
| 10 | 1024 | QAM | 3/4 | 1 | 234 | 1755 |
| 8 | 256 | QAM | 3/4 | 1 | 234 | 1404 |
| 6 | 64 | QAM | 3/4 | 1 | 234 | 1053 |
| 4 | 16 | QAM | 3/4 | 1 | 234 | 702 |
| 2 | QPSK | | 3/4 | 1 | 234 | 351 |
| 3 | 16 | QAM | 1/2 | 1 | 234 | 468 |

| | | | | | |
|---|---|---|---|---|---|
| 1 | QPSK | 1/2 | 1 | 234 | 237 |
| 0 | BPSK | 1/2 | 1 | 234 | 117 |

These different N_{DBPS} of the same code rate family as PHY parameters can be included in the TXVECTORs that can assist in link adaptation with HARQ soft combining.

For link adaption with soft combining, the PPDU transmit procedure changes as follows: When the PHY layer is triggered to transmit a PPDU together with TXVECTOR that shall be applied, the MAC layer provides other PHY parameter sets with which the current transmission should be “soft combinable”. Logically, multiple TXVECTORs may be supplied each representing different PHY parameter sets. Based on this information, the PHY layer computes a common PSDU_LENGTH that is same for all PHY parameter sets, based on which the padding is done. The pre-FEC padding in the PHY layer, and the MAC layer is as defined above, but must be identical, e.g. standardized, among the transmissions for soft combining.

Once the common PSDU_LENGTH and associated padding have been defined, the initial transmission is done, and one or more retransmissions will follow on the same PSDU content and padding. In the process of transmission of the same data field for soft combining, each time all PHY parameter sets that may be used now or later or in the past for this particular data field shall be attached. It may happen that not all of the attached PHY parameters are actually used, because a transmission was successfully received or because a PHY parameters set turned out to be not practical. However, it is not advisable to put too many PHY parameter sets, because it may result in excessive padding of each transmission reducing the spectral efficiency.

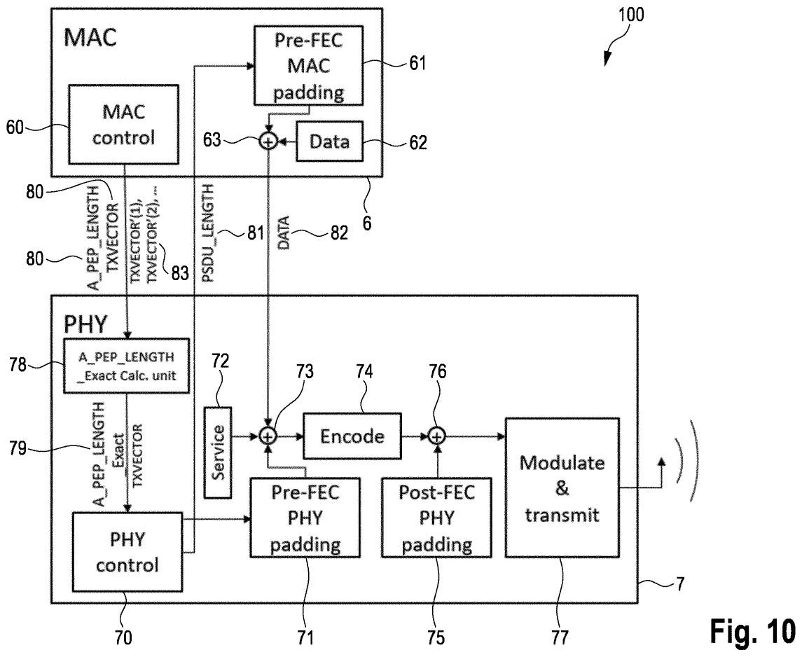

FIG. 10 shows a schematic diagram of an embodiment of a transmitter 100 according to the present disclosure to illustrate the transmission process and in particular the padding process as present according to the present disclosure in more detail. The same reference signs are used as in FIG. 6 to indicate the various elements and pieces of data use by the transmitter 100.

According to the modified layout of the transmitter 100 shown in FIG. 10, the MAC control unit 60—differently from the MAC control unit 60 of the conventional transmitter 5 shown in FIG. 6—does not only provide the TXVECTOR 80 to be used for the current transmission to the PHY layer 7, but also one or more TXVECTOR′ (n) (n=1, 2 in FIG. 10) 83, which indicate PHY parameters for either past or potential future transmissions. A TXVECTOR′ 83 may be different from TXVECTOR 80 in terms of TXVECTOR′ 83 not having A_PEP_LENGTH information 84, because this is anyway identical for each transmission. On top of that, it may be envisioned that TXVECTOR′ 83 holds just those PHY parameters that are different from the current transmission defined by TXVECTOR 80. This mechanism requires that all TXVECTOR 80 and TXVECTOR′ 83 if present shall provide the same length and content of a particular data field for each transmission.

An A_PEP_LENGTH_Exact calculation unit 78 within the PHY layer processing unit 7 takes TXVECTORs 80, 83 as input containing a A_PEP_LENGTH 84 desired by the MAC layer with different PHY parameters. For example, this different PHY parameter set consists of different MCS (which corresponds to different N_{DBPS}) from the same code rate family shown in Table 1 depicted in FIG. 7 that can be used for link adaptation with HARQ soft combining. For the supplied TXVECTORs 80, 83, the A_PEP_LENGTH_Exact calculation unit 78 carries out the following steps to compute the A_PEP_LENGTH_Exact 79 with no Pre-FEC padding that provides the common PSDU_LENGTH for all different N_{DBPS} which makes the retransmissions soft combinable.

In a first step the N_{DBPS} is determined for each supplied PHY parameter set in TXVECTORs 80, 83. In a second step each N_{DBPS} is factorized. In a third step the special factor N_{DBPS,max,div} is determined by taking the LCM (Least Common Multiple) of all N_{DBPS} and the factor 8 to make the calculation in bits. In a fourth step A_PEP_LENGTH_Exact 79 is computed that requires no PHY padding using Eq. (7) below:

$$A\_PEP \_LENGTH \_Exact = ( ⌈ \frac{8 * A\_PEP \_LENGTH + {N}_{s e r v i c e}}{{N}_{DBPS , max , Div}} ⌉ {N}_{DBPS , max , Div} - {N}_{s e r v i c e} ) \frac{1}{8} \qquad ( 7 )$$

With this A_PEP_LENGTH_Exact 79, the PHY control unit 70 computes the PSDU_LENGTH 81 conventionally which will be the common PSDU_LENGTH for all different N_{DBPS} that are taking part in link adaptation.

For example if a desired A_PEP_LENGTH=2000 bytes and 3 PHY parameter sets with MCS=13, 11, 7 and their corresponding N_{DBPS} are to be used as shown in the following Table 3, then the special factor N_{DBPS,max,div} can be calculated as LCM of all N_{DBPS} and a factor 8.

TABLE 3

| MCS | Code Rate | Mod | | N_{DBPS} | Factors (N_{DBPS}) |
|---|---|---|---|---|---|
| 13 | 5/6 | 4096 | QAM | 2340 | 39 *5 *3 * 2 * 2 |
| 11 | 5/6 | 1024 | QAM | 1950 | 39 * 5 * 5 * 2 |
| 7 | 5/6 | 64 | QAM | 1170 | 39 *5 *3 * 2 |

| | |
|---|---|
| Extra factor 8 to keep the N_{DBPS, maxDiv} in bits | 2 * 2 * 2 |
| LCM = | 39 * 5 *5 *3 *2 * 2 * 2 |
| N_{DBPS, maxDiv} = | 23400 bits |

Hence, A_PEP_LENGTH_Exact 79 in bytes can be calculated as in Eq. (7).

$$A\_PEP \_LENGTH \_Exact = 2923 bytes .$$

After the calculation of A_PEP_LENGTH_Exact 79 with no Pre-FEC padding (N_{PAD,pre-FEC}=0), the common PSDU_LENGTH 81 for all N_{DBPS} can be computed from Eq. (3) as

$$PSDU\_LENGTH = ⌊ \frac{8 \cdot A\_PEP \_LENGTH \_Exact}{8} ⌋ = A\_PEP \_LENGTH \_Exact$$

This common PSDU_LENGTH 81 can also be achieved by some other A_PEP_LENGTH below this A_PEP_LENGTH_Exact with some fixed same pre-FEC padding p′ because of the ceiling operation in Eq. (5). Hence, a range of A_PEP_LENGTH including A_PEP_LENGTH_Exact can provide the same PSDU_LENGTH. Thus, the length of the data field (N_{pld}) for all N_{DBPS} used in link adaptation with HARQ soft combining is computed as in Eq. (4):

$${N}_{p l d} = {N}_{s e r v i c e} + 8 * PSDU\_LENGTH = 16 + 8 * 2923 = 23400 bits .$$

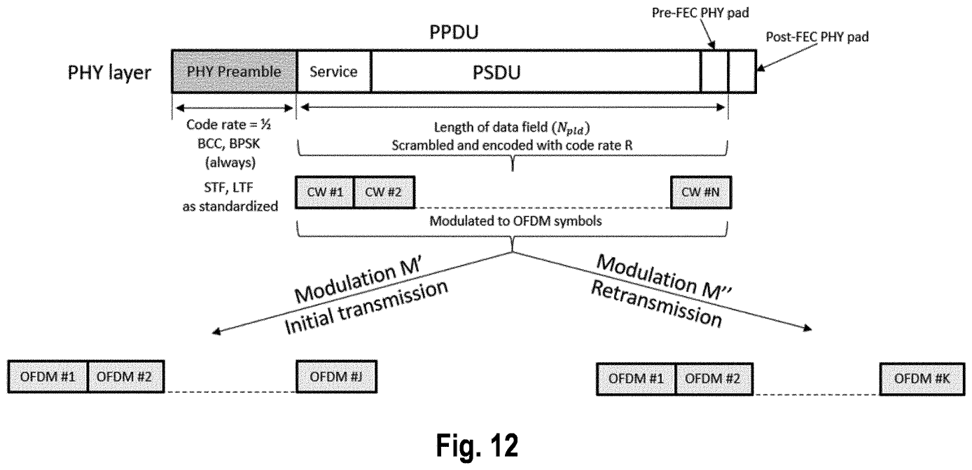

The codeword structure for the initial transmission (first row) and for the retransmission (second row) for N_{pld}=23400 bits is shown in FIG. 11. As can be seen in FIG. 11, the codeword structure is identical and is thus soft combinable.

FIG. 12 shows a diagram illustrating the codeword structure for an initial transmission and for a retransmission with different modulation order. As shown in FIG. 12, the payload bits of the data field of a PPDU are scrambled and encoded with the same code rate R for the initial transmission and for the retransmission. Only the modulation scheme is changed, i.e. M′ is used for the initial transmission and M″ is used for the retransmission. Consequently, the number of OFDM symbols changes too.

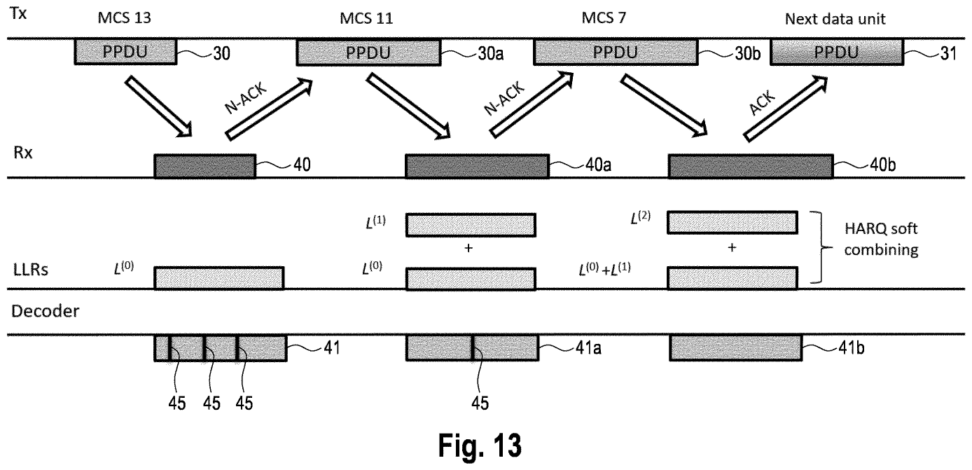

FIG. 13 shows a schematic diagram of an embodiment of a communication scheme according to the present disclosure. It shows particularly an exemplary link adaptation protocol with HARQ soft combining. The same reference signs as shown in FIG. 4 are used. According to this communication scheme, based on received negative acknowledgement or no response feedback, the transmitter lowers its MCS from same code rate family (in this example MCS 13, 11 and 7) in each retransmission to adapt the link. Like in the conventional communication scheme illustrated in FIG. 4, for the initial transmission of the PPDU 30 and the two retransmissions 30a, 30b a different MCS is chosen (in particular by the MAC layer), but according to the communication scheme according to the present disclosure the different MCS used for the transmission 30 and the retransmissions 30a, 30b all belong to the same code rate family, i.e. the code rate is identical (e.g. 5/6) for all three transmissions 30, 30a, 30b.

At the receiver side, the erroneously received PPDUs 40, 40a are stored for HARQ soft combining. The LLR values L⁽⁰⁾, L⁽¹⁾ of these erroneous data units 40, 40a are combined with the LLR values L⁽²⁾ of the newly retransmitted PPDU 40b (if Chase combining is applied; as shown in FIG. 13) or only additional parity information of the newly retransmitted PPDU 40b is used (as incremental redundancy) together with the stored erroneously received PPDUs 40, 40a to decode the PPDU (in another embodiment, the idea of Chase combining and incremental redundancy may be used together).

According to IEEE 802.11 EHT standard specifications, there are certain MCSs that have the same code rate as 5/6, 3/4 or 1/2 as shown in Table 4 below. Hence, while adapting the link for soft combining, only the modulation scheme may change in the consecutive retransmissions as denoted by Tx count which starts with 0 for the initial transmission, 1 for first retransmission and so on. The Tx count numbering is exemplary and different settings may be applicable in different scenarios. It is possible to consider only a subset of the MCS of a particular code rate set, e.g., MCS 11 and MCS 9 only.

TABLE 4

| Tx count | MCS | Mod | | Code Rate (R) |
|---|---|---|---|---|
| 0 | 13 | 4096 | QAM | 5/6 |
| 1 | 11 | 1024 | QAM | 5/6 |
| 2 | 9 | 256 | QAM | 5/6 |
| 3 | 7 | 64 | QAM | 5/6 |
| 0 | 12 | 4096 | QAM | 3/4 |
| 1 | 10 | 1024 | QAM | 3/4 |
| 2 | 8 | 256 | QAM | 3/4 |
| 3 | 6 | 64 | QAM | 3/4 |
| 4 | 4 | 16 | QAM | 3/4 |
| 5 | 2 | QPSK | | 3/4 |
| 0 | 3 | 16 | QAM | 1/2 |

| | | | |
|---|---|---|---|
| 1 | 1 | QPSK | 1/2 |
| 2 | 0 | BPSK | 1/2 |

On top of changing the MCS (under the restrictions above) for different transmissions, one or more of the following PHY parameters may be subject to changes too:
Number of spatial streams (N_{SS})
Bandwidth (BW)
Resource unit (RU) size
Space-time block coding (STBC)
Dual carrier modulation (DCM)
PPDU format
Number of OFDM subcarriers.

All parameters above have the properties that they impact the number of data bits per OFDM symbol N_{DBPS}. For example, a double number of spatial streams N_{SS} ends in a doubled N_{DBPS}, as shown in Eq. (4), if the other parameters are unchanged.

In principle, any combination is feasible. For example, the following combinations may be used as PHY parameter set for soft combination of data payload: (MCS: 13, N_{SS}: 2); (MCS: 11, N_{SS}: 2); (MCS: 11, N_{SS}: 1). Generally, there are parameters that can be changed but have no impact to encoding or N_{DBPS}. Those parameters are transparent for the envisioned mechanism and may included one or more of: guard interval length, length of channel estimation field (LTF: Long Training Field), beamforming, presence of midamble, and spatial reuse parameters.

In the following some exemplary cases that are based on same code rate family with changing PHY parameter MCS will be explained.

In a first case the following parameter are used: (R, N_{SS}, N_{SD})=(5/6, 1,234). For code rate R=5/6 family, N_{DBPS,maxDiv} can be calculated as shown below in Table 5 under the assumption that all MCS may potentially be used for link adaption.

TABLE 5

| Tx count | MCS | Mod | | NDBPS | Factors (NDBPS) |
|---|---|---|---|---|---|
| 0 | 13 | 4096 | QAM | 2340 | 39 *5 *3 * 2 * 2 |
| 1 | 11 | 1024 | QAM | 1950 | 39 * 5 * 5 * 2 |
| 2 | 9 | 256 | QAM | 1560 | 39 *5 * 2 * 2 * 2 |
| 3 | 7 | 64 | QAM | 1170 | 39 *5*3*2 |

| Extra factor 8 to keep the N_{DBPS, maxDiv} in bits | 2 * 2 * 2 |
|---|---|
| N_{DBPS, maxDiv} = | 39 *5 *5*3*2*2*2= |
| | 23400 bits |

As shown in Table 6, for A_PEP_LENGTH=2000 bytes, A_PEP_LENGTH_Exact=2923 bytes which is equal to common PSDU_LENGTH and length of data field N_{pld}=2925 bytes. A_PEP_LENGTH range from 2890-2923 bytes provides the same PSDU_LENGTH and N_{pld} with same pre-FEC padding p′ bytes in all MCS.

TABLE 6

| | | | | A_PEP_{—} | | | | |
|---|---|---|---|---|---|---|---|---|
| | | | | LENGTH | PSDU_{—} | Pre- FEC | | |
| Tx | | | N_{DBPS} | range | LENGTH | Pad (p′) | | N_{pld} |
| count | MCS | Mod | (bits) | (bytes) | (bytes) | MAC | PHY | (bytes) |
| 0 | 13 | 4096 QAM | 2340 | 2890 . . . 2923 | 2923 | 33 . . . 0 | 0 | 2925 |
| 1 | 11 | 1024 QAM | 1950 | 2890 . . . 2923 | 2923 | 33 . . . 0 | 0 | 2925 |
| 2 | 9 | 256 QAM | 1560 | 2890 . . . 2923 | 2923 | 33 . . . 0 | 0 | 2925 |
| 3 | 7 | 64 QAM | 1170 | 2890 . . . 2923 | 2923 | 33 . . . 0 | 0 | 2925 |

The example above assumes that all MCS of the code rate 5/6 family can potentially be used in a retransmission. If one would not used, MCS 11 for example, then N_{DBPS,maxDiv}=39*5*3*2*2*2=4680 bits and A_PEP_LENGTH_Exact=2338 bytes which is significantly less than the previous 2923 bytes. Therefore, PPDUs can be created with lower quantization of PPDU length if 1024-QAM would be excluded from the MCS to be potentially used in link adaption for soft combination of a particular data field. In this regard, the selection of PHY parameters that can be used for link adaption in soft combining should be carefully selected.

In a second case the following parameter are used: (R, N_{SS}, N_{SD})=(3/4, 1,234). For code rate R=3/4 family, N_{DBPS,maxDiv} can be calculated as shown below in Table 7 under the assumption that all MCS may potentially be used for link adaption.

TABLE 7

| Tx count | MCS | Mod | | NDBPS | Factors (NDBPS) |
|---|---|---|---|---|---|
| 0 | 12 | 4096 | QAM | 2106 | 39 *3 *3*3 * 2 |
| 1 | 10 | 1024 | QAM | 1755 | 39 * 3 * 3 * 5 |
| 2 | 8 | 256 | QAM | 1404 | 39 * 3 *3 * 2 * 2 |
| 3 | 6 | 64 | QAM | 1053 | 39 * 3 * 3 * 3 |
| 4 | 4 | 16 | QAM | 702 | 39 * 3 * 3 * 2 |

| | | | | |
|---|---|---|---|---|
| 5 | 2 | QPSK | 351 | 39 * 3 * 3 |

| Extra factor 8 to keep the N_{DBPS, maxDiv} in bits | 2 * 2 * 2 |
|---|---|
| N_{DBPS, maxDiv} = | 39 *3 *3*3*5 * 2 * 2 * 2 = |
| | 42120 bits |

As shown in Table 8, for A_PEP_LENGTH=5000 bytes, A_PEP_LENGTH_Exact=5263 bytes which is equal to common PSDU_LENGTH and length of the data field N_{pld}=5265 bytes. A_PEP_LENGTH range from 5253-5263 bytes provides the same PSDU_LENGTH and N_{pld} with same pre-FEC padding, p′ bytes in all MCS.

TABLE 8

| | | | | A_PEP_{—} | | | | |
|---|---|---|---|---|---|---|---|---|
| | | | | LENGTH | PSDU_{—} | Pre- FEC | | |
| Tx | | | N_{DBPS} | range | LENGTH | Pad (p′) | | N_{pld} |
| count | MCS | Mod | (bits) | (bytes) | (bytes) | MAC | PHY | (bytes) |
| 0 | 12 | 4096 QAM | 2106 | 5253 . . . 5263 | 5263 | 10 . . . 0 | 0 | 5265 |
| 1 | 10 | 1024 QAM | 1755 | 5253 . . . 5263 | 5263 | 10 . . . 0 | 0 | 5265 |
| 2 | 8 | 256 QAM | 1404 | 5253 . . . 5263 | 5263 | 10 . . . 0 | 0 | 5265 |
| 3 | 6 | 64 QAM | 1053 | 5253 . . . 5263 | 5263 | 10 . . . 0 | 0 | 5265 |
| 4 | 4 | 16 QAM | 702 | 5253 . . . 5263 | 5263 | 10 . . . 0 | 0 | 5265 |
| 5 | 2 | QPSK | 351 | 5253 . . . 5263 | 5263 | 10 . . . 0 | 0 | 5265 |

In a third case the following parameter are used: (R, N_{SS}, N_{SD})=(1/2, 1, 234). For code rate R=1/2 family, N_{DBPS,maxDiv} can be calculated as shown below in Table 9 under the assumption that all MCS may potentially be used for link adaption.

TABLE 9

| Tx count | MCS | Mod | NDBPS | Factors (NDBPS) |
|---|---|---|---|---|
| 0 | 3 | 16 QAM | 468 | 39 *3 * 2 * 2 |
| 1 | 1 | QPSK | 234 | 39 * 3 * 2 |
| 2 | 0 | BPSK | 117 | 39 * 3 |

| Extra factor 8 to keep the N_{DBPS, maxDiv} in bits | 2 * 2 * 2 |
|---|---|
| N_{DBPS, maxDiv} = | 39 * 3 * 2 * 2 * 2 = 936 |
| | bits |

As shown in Table 10, for A_PEP_LENGTH=100 bytes, A_PEP_LENGTH_Exact=115 bytes which is equal to common PSDU_LENGTH and length of the data field N_{pld}=117 bytes. A_PEP_LENGTH range from 112-115 bytes provides the same PSDU_LENGTH and N_{pld} with same pre-FEC padding, p′ bytes in all MCS.

TABLE 10

| | | | | A_PEP_{—} | | | | |
|---|---|---|---|---|---|---|---|---|
| | | | | LENGTH | PSDU_{—} | Pre- FEC | | |
| Tx | | | N_{DBPS} | range | LENGTH | Pad (p′) | | |
| count | MCS | Mod | (bits) | (bytes) | (bytes) | MAC | PHY | N_{pld} |
| 0 | 3 | 16 QAM | 468 | 112 . . . 115 | 115 | 3 . . . 0 | 0 | 117 |
| 1 | 1 | QPSK | 234 | 112 . . . 115 | 115 | 3 . . . 0 | 0 | 117 |
| 2 | 0 | BPSK | 117 | 112 . . . 115 | 115 | 3 . . . 0 | 0 | 117 |

Hence, after selection of RU and N_{SS}, any of the above cases for the same code rate MCS (as required) can be chosen for the link adaptation with HARQ soft combining with specific A_PEP_LENGTH that can be calculated as above.

As illustrated in the three above examples, the selection of PHY parameters that can potentially be used should be carefully selected in order to achieve a low N_{DBPS,maxDiv} to avoid coarsly quantized PSDU length which may result in excessive padding. Further, not only a single A_PEP_LENGTH but a range is supported which may additionally help to avoid or reduce padding.

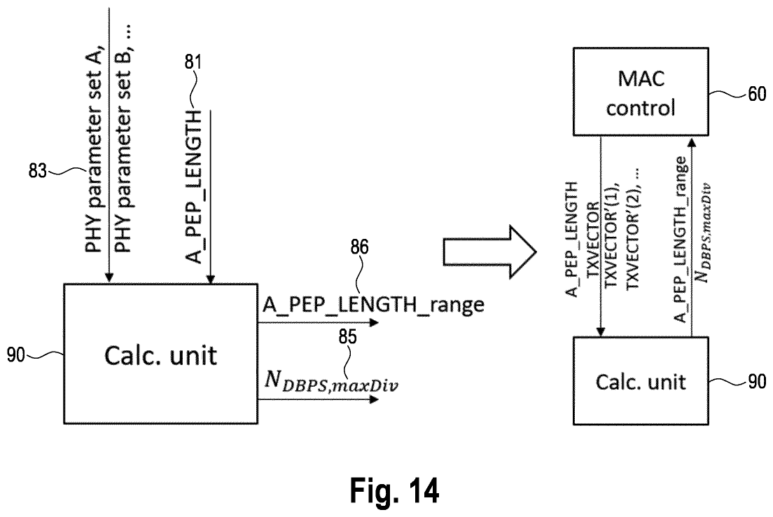

FIG. 14 shows a schematic diagram of a calculation unit 90 that is configured to recommend a range of A_PEP_LENGTHs. The calculation unit 90 can compute N_{DBPS,maxDiv} 85 and/or the range of A_PEP_LENGTHs 86 before initiating a transmission. Such a unit may reside in the PHY layer 7 or the MAC layer 6 of the transmitter 100 shown in FIG. 10. Its input interfaces are sets of PHY parameters (e.g. multiple TXVECTORS) 83 and/or A_PEP_LENGTH 81, whereas its output interfaces are N_{DBPS,maxDiv} 85 and/or A_PEP_LENGTH_range 86.

Basically, the calculation unit 90 is a kind of recommendation unit which recommends a range of A_PEP_LENGTHs 86 such that the MAC layer 6 can try to fill A_PEP_LENGTH as good as possible. In an embodiment, the calculation unit 90 may replace or be included in the A_PEP_LENGTH_Exact unit 78, except that it determines a range of A_PEP_LENGTHs that would result in the same PSDU_LENGTH. Without the calculation unit, the MAC layer 6 may need to do excessive padding especially when PSDU_LENGTH is much larger than A_PEP_LENGTH, but with this calculation unit 90 further MAC layer data units may e.g. be added such that padding is minimized.

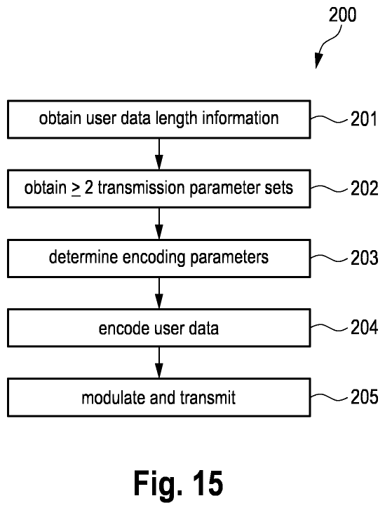

FIG. 15 shows a flow chart of a communication method 200 according to the present disclosure. The communication method 200 is carried out by a transmitter (first communication device), e.g. the transmitter 100 shown in FIG. 10 (in particular in the A_PEP_LENGTH_Exact calculation unit 78), that is configured to communicate with a receiver (second communication device). The transmitter generally comprises circuitry (e.g. a processor, computer, dedicated processing hardware, etc.) to carry out the steps of the communication method but may alternatively including separate units that perform the different steps. In an embodiment the communication method is implemented in software as computer program that runs on a corresponding computer or processor.

In a first step 201 of the communication method 200 user data length information (A_PEP_LENGTH 84 in the embodiment shown in FIG. 10) is obtained (received or retrieved), in particular from the MAC layer 6. The user data length information indicates the length of one or more data units of user data to be transmitted to the receiver.

In a second step 202 of the communication method 200 obtain at least two transmission parameter sets (TXVECTOR 80 and TXVECTOR(s) 83 in the embodiment shown in FIG. 10) each including transmission parameters for use in the transmission of the user data, the at least two transmission parameter sets having one or more different parameter values.

In a third step 203 of the communication method 200 determine, from the user data length information and the at least two transmission parameter sets, encoding parameters (such as code rate, shortening bits, etc.) that are identical regardless which transmission parameter set is used for transmission of the user data. Hence, in the initial transmission and any potential retransmission the same encoding parameters are used, whereas modulation parameter (as specified in MCS) changes for a retransmission compared to the initial transmission and an earlier retransmission of the same data unit. The identical encoding parameters may be determined in the A_PEP_LENGTH_Exact calculation unit 78 (see FIG. 10), and in fact the A_PEP_LENGTH Exact value causes the identical encoding parameters to be computed, preferably in the PHY control unit 70.

In a fourth step 204 of the communication method 200 the user data are encoded into transmission data units (also called codewords; in rare cases there is only a single transmission data unit/codeword) according to the determined encoding parameters.

In a fifth step 205 of the communication method 200 modulate and transmit the transmission data units to the second communication device according to one of the transmission parameter sets (one of the TXVECTOR 80 and TXVECTOR(s) 83 in the embodiment shown in FIG. 10). The modulation thus depends on the one of the transmission parameter sets, whereas the encoding depends on the at least two transmission parameter sets. The transmission data units hence generally represent codewords (i.e. the output of the encoder) and not OFDM symbols (i.e. the output of the modulator).

In summary, according to the present disclosure, link adaptation is proposed in the context of Hybrid ARQ soft combining techniques such as Chase combining (CC) or/and incremental redundancy (IR). In order to implement soft combining of initial transmission with retransmission, it is provided that the encoding structure is unchanged between each transmission. Therefore, a mechanism is presented that ensures the same encoding structure even though one or more PHY parameters change over the process of (re) transmissions. In more detail, the length of the data field of a PPDU is selected such that, after PHY processing operations, it results always in the same size, regardless of which PHY parameters are applied.

Thus, the foregoing discussion discloses and describes merely exemplary embodiments of the present disclosure. As will be understood by those skilled in the art, the present disclosure may be embodied in other specific forms without departing from the spirit or essential characteristics thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure. Further, such a software may also be distributed in other forms, such as via the Internet or other wired or wireless telecommunication systems.

The elements of the disclosed devices, apparatus and systems may be implemented by corresponding hardware and/or software elements, for instance appropriated circuits. A circuit is a structural assemblage of electronic components including conventional circuit elements, integrated circuits including application specific integrated circuits, standard integrated circuits, application specific standard products, and field programmable gate arrays. Further a circuit includes central processing units, graphics processing units, and microprocessors which are programmed or configured according to software code. A circuit does not include pure software, although a circuit includes the above-described hardware executing software.

It follows a list of further embodiments of the disclosed subject matter:
1. First communication device configured to communicate with a second communication device, the first communication device comprising circuitry configured to
   obtain user data length information indicating the length of one or more data units of user data to be transmitted to the second communication device;
   obtain at least two transmission parameter sets each including transmission parameters for use in the transmission of the user data, the at least two transmission parameter sets having one or more different parameter values;
   determine, from the user data length information and the at least two transmission parameter sets, encoding parameters that are identical regardless which transmission parameter set is used for transmission of the user data;
   encode the user data into transmission data units according to the determined encoding parameters; and
   modulate and transmit the transmission data units to the second communication device according to one of the transmission parameter sets.
2. First communication device according to embodiment 1, wherein the circuitry is configured to
   determine a unified user data length based on the at least two transmission parameter sets or all transmission parameter sets, and
   use the unified user data length in the determination of the identical encoding parameters.
3. First communication device according to embodiment 2, wherein the circuitry is configured to generate, from the user data, user data units having the determined unified user data length, and to encode the generated user data unit into the transmission data units.
4. First communication device according to any one of the preceding embodiments, wherein the at least two transmission parameter sets indicate at least same code rate.
5. First communication device according to embodiment 1 or 3, wherein the circuitry is configured to add padding bits to the user data and/or to the generated user data units and/or to encoded user data units.
6. First communication device according to any one of the preceding embodiments,
wherein a transmission parameter set includes one or more of;
   modulation coding scheme (MCS);
   number of spatial streams (N_{SS});
   bandwidth (BW);
   resource unit (RU) size;
   space-time block coding (STBC);
   dual carrier modulation (DCM);
   format of data units; and
   number of subcarriers
7. First communication device according to any one of the preceding embodiments, wherein the circuitry is configured to retransmit the same user data of the same user data length using a different one of the at least two transmission parameter sets than the transmission parameter set used for the original transmission of the user data.
8. First communication device according to embodiment 7, wherein the circuitry is configured to use the same padding in the retransmission as used before in the original transmission.
9. First communication device according to embodiment 7 or 8, wherein the circuitry is configured to retransmit the same user data in response to an indication from the second communication device indicating at least one data unit that failed to be received or decoded by the second communication device, in particular in response to not receiving an acknowledgement or receiving a negative acknowledgement after the original transmission.
10. First communication device according to any one of embodiments 7 to 9, wherein the circuitry is configured to include a retransmission indication into the retransmission indicating that the retransmission is for soft combination of the originally transmitted user data with the retransmitted user data, in particular to include the retransmission indication within a preamble of the transmission data units together with parameters of the used transmission parameter set.
11. First communication device according to any one of embodiments 7 to 10, wherein the circuitry is configured to perform one or more further retransmissions of the same user data of the same user data length each time using a different one of the at least two transmission parameter sets than the transmission parameter set used for the original transmission of the user data.
12. First communication device according to embodiment 2, wherein the circuitry is configured to determine the unified user data length by
   determining from the at least two transmission parameter sets an OFDM symbol bit number (N_{DBPS}) representing the number of data bits of an OFDM symbol;
   factorizing the determined OFDM symbol bit number (N_{DBPS});
   determining a factorization number (N_{DBPS,maxDiv}) by taking the least common multiple of some or all factors of the factorization of the OFDM symbol bit number (N_{DBPS}) and a factor 8; and
   determining the unified user data length from the factorization number (N_{DBPS,maxDiv}).

13. First communication device according to any one of the preceding embodiments, wherein the circuitry is configured to determine a range of possible user data lengths that provides the same unified user data length.

14. First communication device according to any one of the preceding embodiments, wherein the circuitry comprises medium access control (MAC) layer circuitry and physical (PHY) layer circuitry,
wherein the MAC layer circuitry is configured to determine the at least two sets of transmission parameters and to pass them to the PHY layer circuitry, and
wherein the PHY layer circuitry is configured to determine the user data length information, encode the user data and modulate and transmit the transmission data units.
15. First communication device according to embodiment 14, wherein the MAC layer circuitry is configured to transmit to the PHY layer circuitry only those parameters of the transmission parameter set to be used for a retransmission that are different from the transmission parameter set used for the original transmission.
16. First communication device according to any one of the preceding embodiments, wherein the circuitry is configured to receive, from the second communication device,
an acknowledgement indicating a reception status of one or more MAC layer data units that are contained within the transmission data units transmitted to the second communication device and/or
a non-acknowledgement or no acknowledgement at all within a predetermined time period from the transmission of the transmission data units to second communication device.
17. First communication device according to any one of the preceding embodiments, wherein the circuitry is configured to include in a retransmitted data unit one or more of the same MAC header, frame body, frame check sequence (FCS), end of frame (EOF) padding, the same service field, the same zero or more delimiters, and, if included, the same physical layer (PHY) padding field as included in the corresponding originally transmitted data unit.
18. First communication device according to any one of the preceding embodiments, wherein the circuitry is configured to transmit to the second communication device includeed in or along with an originally transmitted data unit or a retransmitted data unit decoding information indicating one or more of:
   if soft combining can be applied;
   the type of soft combining;
   the originally transmitted data unit which corresponds to a retransmitted data unit;
   the first code rate; and
   the transmission parameter set used for the original transmission and/or the transmission parameter set used for the retransmission.
19. First communication method of a first communication device configured to communicate with a second communication device, the first communication method comprising
   obtaining user data length information indicating the length of one or more data units of user data to be transmitted to the second communication device;
   obtaining at least two transmission parameter sets each including transmission parameters for use in the transmission of the user data, the at least two transmission parameter sets having one or more different parameter values;
   determining, from the user data length information and the at least two transmission parameter sets, encoding parameters that are identical regardless which transmission parameter set is used for transmission of the user data;
   encoding the user data into transmission data units according to the determined encoding parameters; and
   modulating and transmitting the transmission data units to the second communication device according to one of the transmission parameter sets.
20. A non-transitory computer-readable recording medium that stores therein a computer program product, which, when executed by a processor, causes the method according to embodiment 19 to be performed.
21. A computer program comprising program code means for causing a computer to perform the steps of said method according to embodiment 19 when said computer program is carried out on a computer.

1. First communication device configured to communicate with a second communication device, the first communication device comprising circuitry configured to
obtain user data length information indicating the length of one or more data units of user data to be transmitted to the second communication device;
obtain at least two transmission parameter sets each including transmission parameters for use in the transmission of the user data, the at least two transmission parameter sets having one or more different parameter values;
determine, from the user data length information and the at least two transmission parameter sets, encoding parameters that are identical regardless which transmission parameter set is used for transmission of the user data;
encode the user data into transmission data units according to the determined encoding parameters; and
modulate and transmit the transmission data units to the second communication device according to one of the transmission parameter sets.

2. First communication device according to claim 1, wherein the circuitry is configured to
determine a unified user data length based on the at least two transmission parameter sets or all transmission parameter sets, and
use the unified user data length in the determination of the identical encoding parameters.

3. First communication device according to claim 2, wherein the circuitry is configured to generate, from the user data, user data units having the determined unified user data length, and to encode the generated user data unit into the transmission data units.

4. First communication device according to claim 1, wherein the at least two transmission parameter sets indicate at least same code rate.

5. First communication device according to claim 1, wherein the circuitry is configured to add padding bits to the user data and/or to the generated user data units and/or to encoded user data units.

6. First communication device according to claim 1,
wherein a transmission parameter set includes one or more of;
modulation coding scheme (MCS);
number of spatial streams (N_{SS});
bandwidth (BW);
resource unit (RU) size;
space-time block coding (STBC);
dual carrier modulation (DCM);
format of data units; and
number of subcarriers

7. First communication device according to claim 1, wherein the circuitry is configured to retransmit the same user data of the same user data length using a different one of the at least two transmission parameter sets than the transmission parameter set used for the original transmission of the user data.

8. First communication device according to claim 7, wherein the circuitry is configured to use the same padding in the retransmission as used before in the original transmission.

9. First communication device according to claim 7, wherein the circuitry is configured to retransmit the same user data in response to an indication from the second communication device indicating at least one data unit that failed to be received or decoded by the second communication device, in particular in response to not receiving an acknowledgement or receiving a negative acknowledgement after the original transmission.

10. First communication device according to claim 7, wherein the circuitry is configured to include a retransmission indication into the retransmission indicating that the retransmission is for soft combination of the originally transmitted user data with the retransmitted user data, in particular to include the retransmission indication within a preamble of the transmission data units together with parameters of the used transmission parameter set.

11. First communication device according to claim 7, wherein the circuitry is configured to perform one or more further retransmissions of the same user data of the same user data length each time using a different one of the at least two transmission parameter sets than the transmission parameter set used for the original transmission of the user data.

12. First communication device according to claim 2, wherein the circuitry is configured to determine the unified user data length by
determining from the at least two transmission parameter sets an OFDM symbol bit number (N_{DBPS}) representing the number of data bits of an OFDM symbol;
factorizing the determined OFDM symbol bit number (N_{DBPS});
determining a factorization number (N_{DBPS,maxDiv}) by taking the least common multiple of some or all factors of the factorization of the OFDM symbol bit number (N_{DBPS}) and a factor 8; and
determining the unified user data length from the factorization number (N_{DBPS,maxDiv}).

13. First communication device according to claim 1, wherein the circuitry is configured to determine a range of possible user data lengths that provides the same unified user data length.

14. First communication device according to claim 1,
wherein the circuitry comprises medium access control (MAC) layer circuitry and physical (PHY) layer circuitry,
wherein the MAC layer circuitry is configured to determine the at least two sets of transmission parameters and to pass them to the PHY layer circuitry, and
wherein the PHY layer circuitry is configured to determine the user data length information, encode the user data and modulate and transmit the transmission data units.

15. First communication device according to claim 14, wherein the MAC layer circuitry is configured to transmit to the PHY layer circuitry only those parameters of the transmission parameter set to be used for a retransmission that are different from the transmission parameter set used for the original transmission.

16. First communication device according to claim 1, wherein the circuitry is configured to receive, from the second communication device,
an acknowledgement indicating a reception status of one or more MAC layer data units that are contained within the transmission data units transmitted to the second communication device and/or
a non-acknowledgement or no acknowledgement at all within a predetermined time period from the transmission of the transmission data units to second communication device.

17. First communication device according to claim 1, wherein the circuitry is configured to include in a retransmitted data unit one or more of the same MAC header, frame body, frame check sequence (FCS), end of frame (EOF) padding, the same service field, the same zero or more delimiters, and, if included, the same physical layer (PHY) padding field as included in the corresponding originally transmitted data unit.

18. First communication device according to claim 1, wherein the circuitry is configured to transmit to the second communication device included in or along with an originally transmitted data unit or a retransmitted data unit decoding information indicating one or more of:
if soft combining can be applied;
the type of soft combining;
the originally transmitted data unit which corresponds to a retransmitted data unit;
the first code rate; and
the transmission parameter set used for the original transmission and/or the transmission parameter set used for the retransmission.

19. First communication method of a first communication device configured to communicate with a second communication device, the first communication method comprising:
obtaining user data length information indicating the length of one or more data units of user data to be transmitted to the second communication device;
obtaining at least two transmission parameter sets each including transmission parameters for use in the transmission of the user data, the at least two transmission parameter sets having one or more different parameter values;
determining, from the user data length information and the at least two transmission parameter sets, encoding parameters that are identical regardless which transmission parameter set is used for transmission of the user data;
encoding the user data into transmission data units according to the determined encoding parameters; and
modulating and transmitting the transmission data units to the second communication device according to one of the transmission parameter sets.

20. A non-transitory computer-readable recording medium that stores therein a computer program product, which, when executed by a processor, causes the method according to claim 19 to be performed.
